(19) United States
(12) Patent Application Publication
(10) Pub. No.: US 2015/0084222 A1
(43) Pub. Date: Mar. 26, 2015

(54) FILAMENT FOR FUSED DEPOSIT MODELING

(71) Applicant: Fenner, U.S., Inc., Manheim, PA (US)

(72) Inventors: Stephen F. Heston, Longmont, CO (US); Anna Totaro, Hummelstown, PA (US)

(21) Appl. No.: 14/495,491

(22) Filed: Sep. 24, 2014

Related U.S. Application Data
(60) Provisional application No. 61/881,690, filed on Sep. 24, 2013.

(51) Int. Cl. B29C 47/00; B29C 47/92; B29C 67/00

(52) U.S. Cl. CPC B29C 47/003; B29C 67/0055; B29C 47/0057; B29C 47/92; B29C 2947/92123; B29C 2947/92447; B29C 2947/92619; B29K 2075/00
USPC 264/40.7; 425/166; 264/308

(57) ABSTRACT

An apparatus for forming an object by an additive process, commonly referred to as 3-D printing, is provided. The apparatus includes a filament comprising a series of irregularities along the length of the filament, a nozzle depositing a layer of melted material onto a surface and a feeder feeding the filament to the nozzle. A heating element melts the filament and a controller controls the position of the nozzle in a plane to control the configuration of the layer of melted material deposited by the nozzle. Additionally, a method for forming polymer filament used in 3-D printing devices is also provided. The method includes the steps of melting a polymer, selecting an extrusion characteristic calculated to induce a polymer flow instability and extruding the melted polymer using the selected extrusion characteristic to produce an extrusion having distortions created by the polymer flow instability.

### PRIORITY CLAIM

This application claims priority under 35 U.S.C.§119 to U.S. Provisional Application No. 61/881,690 filed Sep. 24, 2013. The entire disclosure of the foregoing application is hereby incorporated herein by reference.

### FIELD OF THE INVENTION

The present invention relates to the field of additive manufacturing technology commonly referred to as fused deposition modeling or fused filament fabrication. More specifically, the present invention relates to an additive manufacturing technology using low durometer materials having improved characteristics for feeding the materials.

### BACKGROUND

The use of fused deposition modeling or fused filament fabrication, which are collectively referred to as FFF herein, have grown rapidly in the 21^{st} century and show promise in a variety of fields. Commonly referred to as 3-D printing, these additive manufacturing techniques build 3-dimensional components layer by layer. A variety of materials can be used in the field of FFF, but acrylonitrile butadiene styrene (ABS) and polylactic acid (PLA) are the predominant materials used. ABS and PLA have properties that work well in the FFF process, but the materials tend to be rigid, resulting in products that are brittle at room temperature.

On the other hand, materials such as polyurethanes, silicones, and certain nylon compositions generally provide a broader range of mechanical properties, such as reduced modulus, higher elasticity, and reduced brittleness. However, in many cases the elasticity and reduced stiffness of these materials cause difficulties in many FFF machines. For this reason, despite the advantages for the resulting product, these materials are not yet widely used in FFF machines.

### SUMMARY OF THE INVENTION

In light of the foregoing, the present invention provides low durometer elastomer materials that work efficiently with known additive manufacturing machines, such as FFF machines. In one aspect, the present invention provides an additive manufacturing machine with a spool of low durometer elastomer filament. The outer surface of the filament has reduced tackiness to improve the ability to feed the filament through the FFF machine. For instance, the filament may comprise a plurality of melt fractures that reduce the coefficient of friction of the filament.

According to another aspect, a low durometer filament for an FFF machine is provided. The filament has an elongated axis extending the length of the filament and an outer surface. The outer surface comprises a plurality of melt fractures extending transverse the elongated axis. For example, the plurality of melt fractures may comprise a plurality of ridges running transverse the elongated axis.

In yet another aspect, the present invention comprises a method of using a thermoplastic filament having an elongated axis extending the length of the filament and having a plurality of distortions along the length of the filament. The method comprises the steps of feeding the filament into a nozzle, melting the filament, and selectively controlling the position of the nozzle relative to a platform to deposit a plurality of layers of material to produce a three-dimensional item.

In yet another aspect, the present invention provides a system for producing an object by an additive process. The system includes an elongated filament comprising a series of irregularities along the length of the filament, a nozzle, a feeder for feeding the filament to the nozzle and a heating element for melting the filament into a melted material. A controller controls the position of the nozzle to control the configuration of the layer of melted material deposited by the nozzle. Specifically, the controller may control the operation of the feeder and the position of the nozzle to build a series of layers of melted material to form a three-dimensional object.

### DESCRIPTION OF THE DRAWINGS

The foregoing summary and the following detailed description of the preferred embodiments of the present invention will be best understood when read in conjunction with the appended drawings, in which:

FIG. 1 is a side view of a system for creating three-dimensional objects;

FIG. 2 is an enlarged fragmentary view of an extrusion head of the system illustrated in FIG. 1;

FIG. 3 is an enlarged fragmentary view of a filament used in the system of FIG. 1;

FIG. 4 is a series of enlarged fragmentary views of filaments for the system of FIG. 1.

### DETAILED DESCRIPTION OF THE INVENTION

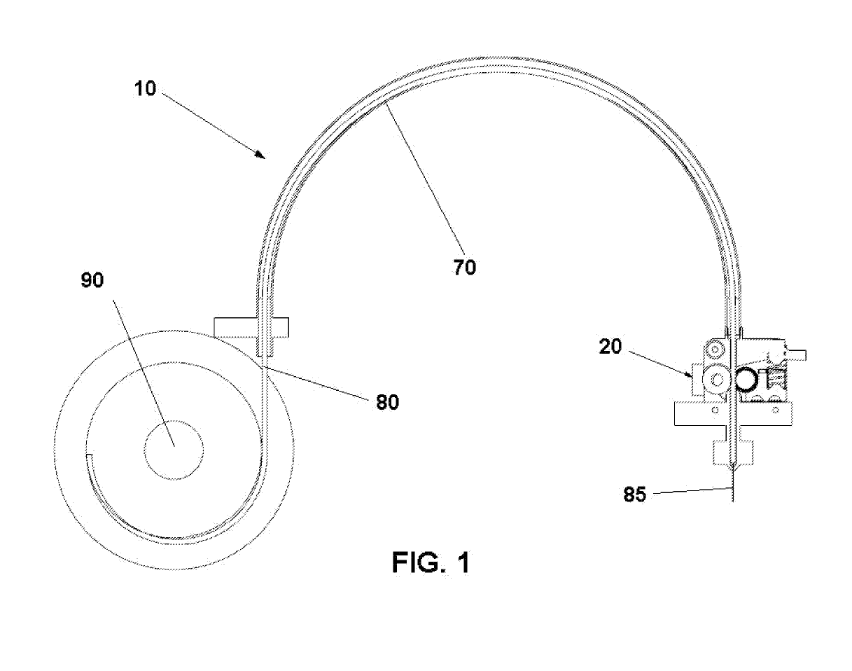

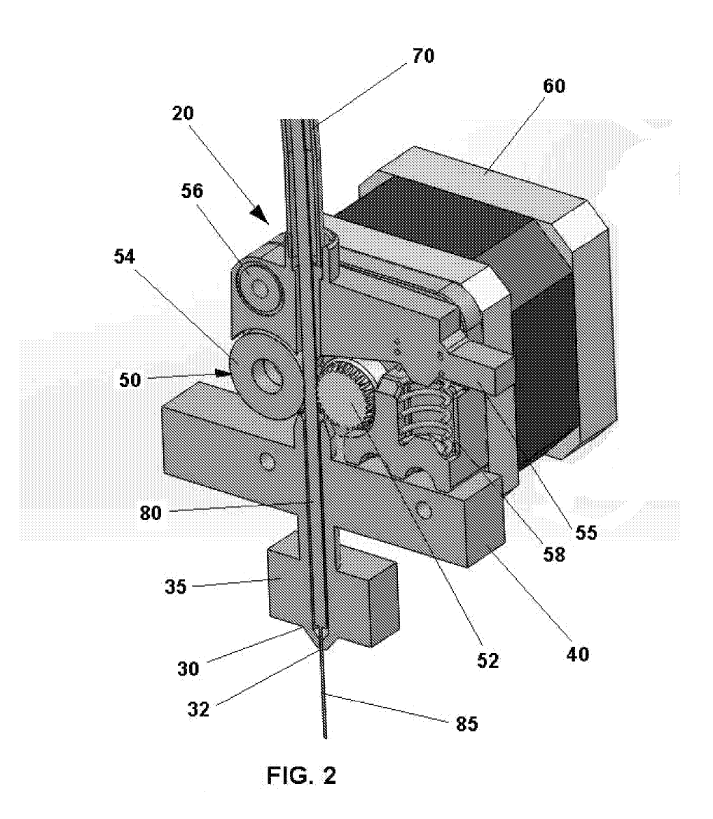

Referring now to the figures in general and to FIGS. 1-2 specifically, a system for creating three-dimensional objects by depositing multiple layers of material is designated generally 10. The system includes a head 20 for selectively depositing melted material 85 onto a support element, such as a planar platform or other stage (not shown). A length of feedstock 80 is fed to the head 20, which melts the feedstock. The melted material 85 is then deposited in a series of layers to build the object as discussed further below.

The system 10 can be any of a variety of additive manufacturing systems.

The system 10 may include a controller for controlling the operation of the head 20 to form an object based on an electronic model of the object. For instance, the electronic model may break the object down into a series of layers. The controller controls the operation of the head to selectively deposit material in accordance with the series of layers that form the electronic model. For instance, the controller may comprise a computer or other microprocessor controlled device that controls the operation of actuators, such as one or more motors that drive the head 20 along two axes in a plane. In this way, the controller controls the position of the head 20 to control where each layer of material is deposited onto a platform or table. By depositing sequential layers of material the system progressively builds the object from numerous layers of deposited material. Alternatively, rather than controlling the position of the head, the system can be configured to move the platform relative to the head 20. In either instance, the system controls the position of the head relative to the platform.

Although the system 10 may be one of a variety of additive manufacturing systems, in the present instance the system is one that includes an extrusion head for extruding the material that forms the object. For instance, the system may be a fused deposition modeling device or fused filament fabrication device, such as one or several systems commonly referred to as a 3-D printing device that extrude thermoplastics and other materials.

Referring to FIG. 2, the details of the head 20 will be described in greater detail. In the present instance, the head is an extrusion head 20 having an input for receiving feedstock 80 that is extruded through a nozzle 30. A feeder 50 positively engages the feedstock to drive the feedstock toward the nozzle 30 in response to signals received from the controller to control the discharge of extruded material from the extrusion head 20.

The feeder 50 includes a drive wheel 52 and an opposing idler wheel 54. The idler wheel 54 is mounted on a pivot arm 55 that pivots around a pivot axis 56. A biasing element 58 biases the arm 55 to bias the idler wheel 54 toward the drive wheel 52. In this way, the drive wheel 52 and idler wheel 54 form a nip to positively engage the feedstock 80. The drive and idler wheels 52, 54 are rotatable wheels so that the wheels rotate as the feedstock is driven through the nip. In the present instance, the drive wheel 52 positively engages the feedstock to drive the feedstock forwardly. For example, the drive wheel may include a plurality of engagement teeth spaced around the circumference of the drive wheel as shown in FIG. 2. The engagement teeth have edges that dig into or bite the feedstock so that rotating the drive wheel drives the material forwardly toward the nozzle 30. Alternatively, the drive wheel 52 may have a different mechanism for engaging the feedstock. For instance, the drive wheel may have a high-friction surface to frictionally engage the feedstock.

Operation of the drive wheel 52 is controlled by a positional controller. For instance, in the present instance a motor 60 such as a stepper motor selectively drives the drive wheel 52. The motor 60 receives signals from a controller, such as the central controller controlling operation of the system. In this way, the motor 60 selectively drives the drive wheel 52 to control the feeding of the feedstock to thereby control the flow of melted material exiting the nozzle 30.

The feeder 50 drives the feedstock 80 through a barrel that extends to the nozzle 30. The nozzle 30 includes a discharge orifice 32 through which the extruded material 85 exits the extrusion head 20. A heating element 35 at the nozzle is operable to heat the feedstock 80 to an elevated temperature above ambient temperature so the material can be extruded through the nozzle. A heat sink 40 is operable to limit the transfer of heat to the feedstock before the feedstock enters the nozzle 30 so that the feedstock does not start to melt before entering the nozzle. The heatsink also limits of transfer of heat from the nozzle to other components of the extrusion head 20.

Referring again to FIG. 1, in the present instance the feedstock 80 comprises an elongated element, such as a filament. The filament 80 may be formed into a variety of shapes, however in the present instance the filament is a substantially cylindrical solid filament. A variety of diameters may be used depending on various factors such as the material from which the filament is formed. In the present instance, the filament 80 is approximately 2 mm in diameter.

The filament 80 may be wound onto a spool 90 to provide a substantially constant supply of material to the extrusion head 20. As the feeder 50 drives the filament forwardly toward the nozzle 30, the feeder pulls the filament from the spool. The filament extends through a hollow feed tube 70 that guides the filament as the filament extends from the spool 90 to the extrusion head 20.

As noted above, the filament may be formed of any of a variety of materials. However, in the present instance the filament is formed of a low durometer material, having one or more of the following materials: silicone, rubber, nylon and/or thermoplastic, such as polyurethane. For instance, the filament material may be formed from a material having a durometer of less than approximately 50 Shore D and greater than approximately 60 Shore A. In particular, the durometer of the filament material may be less than 90 on the Shore A scale and in the present instance is 85 on the Shore A scale. Such low durometer materials tend to have tacky surfaces so that the materials have a generally high coefficient of friction relative to materials such as ABS and PLA.

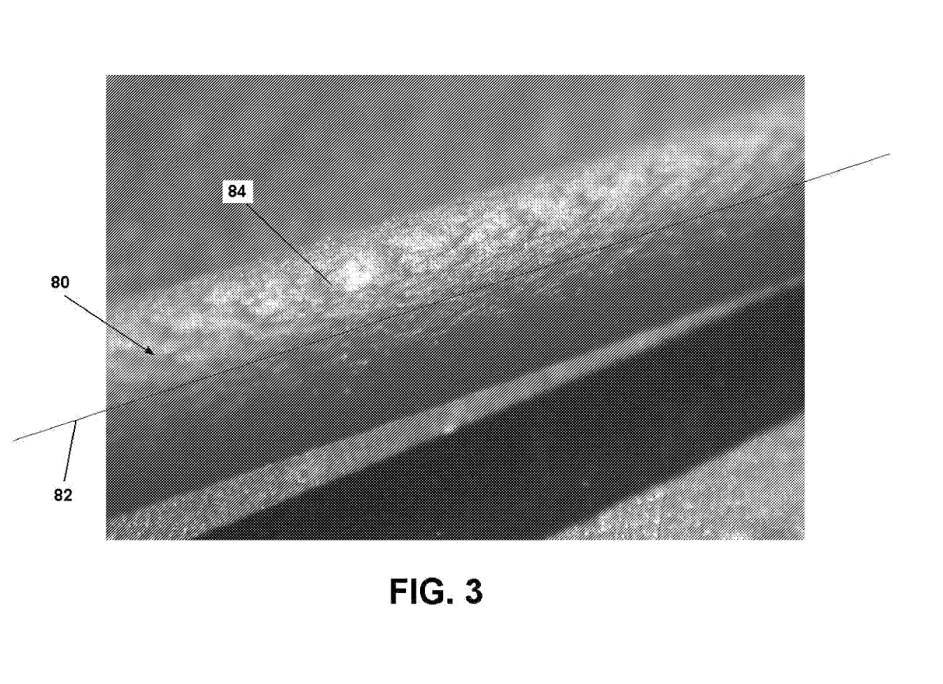

The filament 80 is configured to limit the pull force necessary to draw the filament from the spool and to improve the feeding of low-durometer filaments. Referring to FIG. 3, the filament 80 is an elongated element having a central axis 82 extending along the length of the filament. The filament 80 includes a plurality of distortions or irregularities 84 formed along the length of the filament.

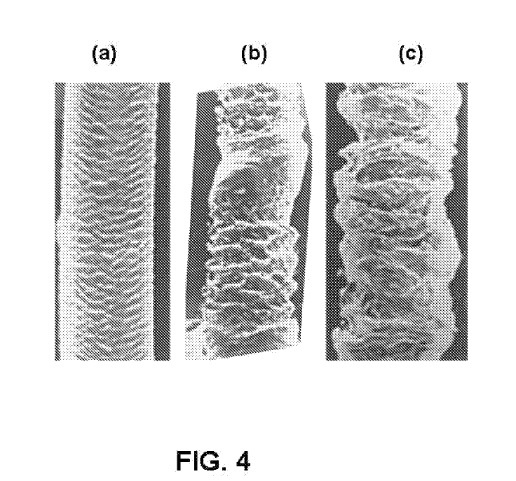

In the present instance, the filament is an extruded element and extrudate irregularities are formed by inducing die flow instabilities during the extrusion process. The extrudate irregularities may comprise surface melt fractures or gross melt fractures. For example, surface melt fractures in the form of surface distortions may be formed on the outer surface of the filament by extruding the filament at a temperature and rate that causes small amplitude periodic surface distortions on the filament. As shown in FIGS. 3 and 4(a), in the present instance, the extrudate irregularities 84 are surface distortions that comprise a series of ridges that extend transverse the axis of the filament 82. Additionally, as shown in FIG. 3, the extrudate irregularities extend over substantially the entire length and substantially the entire surface of the filament. The ridges may be periodic ridges, such as the extrudate irregularity commonly referred to as sharkskin. Although the sharkskin irregularity may extend over only a portion of the filament, as noted above, in the present instance, the sharkskin extends over substantially the entire surface of the filament as shown in FIG. 3.

Surface distortions 84 such as those illustrated in FIGS. 3 and 4(a) may be formed during the process of extruding the filament 80. Specifically, the flow rate of the extrusion material and/or the temperature of the extrusion die and the filament material may be controlled so that the center of the extruded material flows faster than the outer edges of the extrusion where the die walls hinder the flow of the extruded material.

Alternatively, as shown in FIGS. 4(b) & 4(c), gross melt fractures can be induced that more significantly affect the filament extrusion, such as melt fractures that alter the cross-section of the extrusion. Such melt fractures may include, but are not limited to: spiraling, bambooing, regular ripple, random ripple and other melt fractures that create distortions so that the surface of the filament is variable in a radial direction along the length of the filament. In this way, the gross melt fractures may create a series of ridges transverse the axis along which the filament is extruded, which in the present instance, in the filament axis 82.

Configured as discussed above, the system 10 operates as follows. A length of filament 80 having a series of irregularities 84 is provided. The irregularities may be extrudate irregularities forming a plurality of ridges extending transverse the filament axis 82. In the present instance, the irregularities 84 are a plurality of ridges extending generally perpendicular to the filament axis 82. The ridges may be periodic ridges having a small amplitude. Specifically, the amplitude of the ridges may be substantially smaller than the diameter of the filament. The diameter of the filament 80 may vary, for instance, the diameter of the filament may be between 1 and 10 mm. More specifically, the diameter may be less than 5 mm. In particular, the diameter may be between 1.5 mm and 3 mm. In the present instance, the diameter is either 1.75 mm or 3.0 mm.

The length of filament 80 is wound onto a spool 90 and the free end of the filament is fed into the feeder 50 of a deposition machine 10, such as an FFF. The FFF 10 is controlled by a controller having digital instructions to produce a three-dimensional product based on a digital model of the object to be produced. The controller controls the feeder 50 to pull the filament from the spool. In the present instance, the filament is formed of a relatively low durometer material so that the teeth of the drive wheel 52 can dig into or deform the filament radially inwardly to positively engage the filament to feed the filament forwardly. In addition, as discussed above, the filament may have surface irregularities, such as ridges protruding radially outwardly along the surface of the filament. Such surface irregularities extend transverse the longitudinal axis of the filament. Therefore, the surface irregularities also extend transverse the direction of travel as the filament is fed toward the feeder 50. As a result, the surface irregularities are generally parallel to surfaces of the teeth of the drive wheel 52 so that the surface irregularities can also form engagement surfaces or ridges to engage the teeth of the drive wheel 52 to facilitate feeding of the material.

The feeder 50 feeds the filament through the extrusion head 20 to form a flow of melted material discharging from the nozzle 30 from melting the filament. The position of the nozzle 30 is controlled by the controller to move the nozzle within a plane to deposit a layer of melted filament 85 to form a layer of the three-dimensional object on a build platform. After depositing the first layer of material, the system then deposits a subsequent layer of melted filament to build-up a layer on the first layer. The process continues by building up successive layers on top of one another, with the pattern of material being deposited during each layer being controlled by the controller by moving the nozzle along two axes to control the position of the nozzle within a plane. When a layer is complete, the controller may then move the nozzle or the build platform along a third axes transverse the first two axes to raise or lower the nozzle relative to the build platform.

A method for producing the filament 80 used in a deposition machine 10, such as an FFF machine is also provided. The method provides a low-durometer extruded filament having a plurality of irregularities along the length of the filament.

The method of producing the filament comprises the step of melting a polymer. In particular, the polymer is selected to be a low durometer material having less than Shore 50D or between Shore 60A and 90A. For instance, the polymer may be thermoplastic urethane or silicone. Additionally, the polymer may be a mixture of polymeric materials. In the present instance, the filament may be substantially formed of thermoplastic elastomers, such as urethane, meaning that the filament is at least 50% thermoplastic elastomer, and more preferably is at least 70% thermoplastic elastomer, and most preferably is at least 90% thermoplastic elastomer.

The melted material is fed to an extrusion die according to any of a variety of known processes for feeding material to an extrusion die. In the present instance, the extrusion die comprises a capillary die having a round die opening. The feeder feeds the melted polymer to the die head so that the polymer is extruded from the die to form a cylindrical filament. A puller pulls the extrusion to maintain tension on the filament as it emerges from the extrusion die. For instance, the puller may comprise a pair of opposing belts forming a nip that engages the filament to pull the filament.

When the filament emerges from the extrusion die, the filament is at an elevated temperature. Accordingly, the filament may be cooled by any of a variety of means, such as by pulling the filament through a bath of cooling fluid, such as water. After the filament is cooled, the filament is wound onto a spool.

Additionally, it is desirable to maintain a consistent profile for the filament. Accordingly, the process may include a mechanism for measuring a characteristic of the filament, such as the diameter of the filament. Any of a variety of mechanisms can be incorporated to measure the filament between the point that the filament emerges from the die and the filament is wound onto the spool. In the present instance, a non-contact gauge for measuring the diameter of the filament. For instance, the gauge may comprise a plurality of laser elements to measure the filament diameter.

The gauge may automatically detect the diameter of the filament while the filament is moving through the processing line. For instance, it may be desirable to maintain the filament diameter within a tolerance of +/−0.05 mm of the desired diameter, such as 1.75 mm+/−0.05 mm. Similarly, the gauge may be used to measure the roundness of the filament to monitor whether the cross section of the filament is round or oval. For instance, it may be desirable to maintain the filament roundness within a tolerance of +/−0.07 mm.

The gauge may provide a signal indicating that the filament diameter is above or below a pre-determined diameter. In response, the system may alter the speed of either the feeder feeding the melted material to the extrusion die or the system may alter the speed of the puller. Specifically, a central controller, such as a microprocessor may control either the feeder or the puller in response to signals from the gauge indicative of the filament diameter being above or below the pre-determined diameter.

Several characteristics of the extrusion process affect the profile of the extruded filament. For instance, elements that affect the extrusion profile include, but are not limited to: the temperature of the die, the temperature of the thermoplastic material, the temperature of the cooling bath and the flow rate of the material through the die. In order to induce polymer flow instabilities during the extrusion process, one of the characteristics is selected so as to provide the desired melt fracture in the filament. Specifically, the filament may be extruded using the selected extrusion characteristic to provide a filament having extrusion irregularities along the length of the filament. For instance, the extrusion characteristic, such as the flow rate through the die, may be controlled to provide a filament having a melt fracture, such as a plurality of small amplitude ridges around the filament. Specifically, the ridges may have an amplitude that is substantially smaller than the diameter of the filament.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A system for producing an object by an additive process, comprising:
an elongated filament comprising a series of irregularities along the length of the filament;
a nozzle for depositing a layer of melted material onto a surface;
a feeder for feeding the filament to the nozzle;
a heating element for melting the filament into the melted material;
a controller for controlling the position of the nozzle in a plane to control the configuration of the layer of melted material deposited by the nozzle, wherein the controller controls the operation of the feeder and the position of the nozzle to build a series of layers of melted material to form the object.

2. The system of claim 1 wherein the filament is wound onto a spool.

3. The system of claim 1 wherein the irregularities comprise extrudate irregularities.

4. The system of claim 3 wherein the filament comprises an extrusion axis extending the length of the filament and the extrudate irregularities comprise a plurality of ridges extending transverse the extrusion axis.

5. The system of claim 4 wherein the filament has a diameter and the amplitude of the ridges is substantially smaller than the diameter of the filament.

6. The system of claim 4 wherein the extrudate irregularities comprise melt fractures.

7. The system of claim 4 wherein the filament is formed of material having a durometer of less than 50 on the Shore D scale or less than 90 on the Shore A scale.

8. The system of claim 7 wherein the filament material comprises thermoplastic urethane or silicone.

9. (canceled)

10. A method for producing an object by an additive process, comprising the steps of:
selecting a feedstock comprising an elongated filament having a series of irregularities along the length of the filament;
feeding the feedstock to a device operable to melt the filament to form a stream of melted material; and
controlling the stream of melted material to build a series of layers to form an object by an additive process.

11. (canceled)

12. The method of claim 10 wherein the step of selecting feedstock comprises selecting a filament having extrudate irregularities.

13. The method of claim 10 wherein the step of selecting feedstock comprises selecting a filament having an extrusion axis extending the length of the filament and extrudate irregularities comprising a plurality of ridges extending transverse the extrusion axis.

14. The method of claim 10 wherein the step of selecting feedstock comprises selecting a filament having extrudate irregularities comprise melt fractures forming ridges extending transverse an extrusion axis of the filament.

15. The method of claim 10 wherein the step of selecting a feedstock comprises selecting a filament formed of material having a durometer of less than 90 on the Shore A scale or less than 50 on the Shore D scale.

16. The method of claim 10 wherein the step of selecting a feedstock comprises selecting a filament formed of a material comprising thermoplastic urethane or silicone.

17. (canceled)

18. The method of claim 10 wherein the step of selecting a feedstock comprises selecting an extruded feedstock having irregularities formed by polymer flow instabilities.

19. The method of claim 18 wherein the irregularities are small amplitude surface distortions.

20. (canceled)

21. A method for forming polymer filament for use in an apparatus for producing an object by an additive process, wherein the method for forming the polymer filament comprises the steps of:
melting a polymer;
selecting an extrusion characteristic calculated to induce a polymer flow instability;
extruding the melted polymer using the selected extrusion characteristic to produce an elongated substantially solid extrusion, wherein the polymer flow instability creates distortions on the surface of the extrusion;
pulling the elongated extrusion;
automatically measuring the cross-sectional characteristic of the elongated extrusion during the step of pulling; and
varying either the step of extruding or the step of pulling in response to the step of measuring.

22. The method of claim 21 wherein the extrusion characteristic is one of temperature, the rate at which the extrusion is extruded during the step of extruding and the rate at which the extrusion is pulled during the step of pulling.

23. (canceled)

24. The method of claim 23 wherein the step of extruding comprises extruding a filament having a diameter of 1.75 mm with a tolerance of plus or minus 0.05 mm or 3.0 mm with a tolerance of plus or minus 0.05 mm.

25. The method of claim 24 wherein the step of extruding comprises extruding a polyurethane thermoplastic elastomer.

26. The method of claim 21 wherein the step of extruding comprises extruding an extrusion having surface distortions.

27. The method of claim 26 wherein the surface distortions are small amplitude distortions.

28. The method of claim 27 wherein the amplitude of the distortions is substantially smaller that the diameter of the extrusion.

29. The method of claim 27 wherein the surface distortions are sharkskin distortions.

30. The method of claim 27 wherein the surface distortions comprise a plurality of ridges along the length of the extrusion.

31. The method of claim 30 wherein the distortions are periodic.

32. The method of claim 21 comprising the step of cooling the extrusion to form a filament having a durometer less than 90 on the Shore A scale or less than 50 on the Shore D scale.

33-52. (canceled)
